(19) United States
(12) Patent Application Publication
(10) Pub. No.: US 2022/0180443 A1
(43) Pub. Date: Jun. 9, 2022

(54) Investment Entity Management

(71) Applicant: Shoobx, Inc., Boston, MA (US)

(72) Inventors: Steven Paul Papa, Windham, NH (US); Jason M. Furtado, Boston, MA (US); Stephan Richter, Maynard, MA (US); Jennifer Lynn McPhilimy, Watertown, MA (US); Jordan Vance, Watertown, MA (US); Andrej Lebedev, Vilnius (LT)

(21) Appl. No.: 17/547,199

(22) Filed: Dec. 9, 2021

Related U.S. Application Data
(60) Provisional application No. 63/123,461, filed on Dec. 9, 2020.

(51) Int. Cl. G06Q 40/06; H04L 9/40

(52) U.S. Cl. CPC G06Q 40/06; H04L 63/105

(57) ABSTRACT

A system for investment entity management is disclosed. In a first embodiment, at least one database is configured to store: an electronic representation of a portfolio operating company including detailed ownership records; an electronic representation of an investment fund entity for investing in one or more portfolio operating companies, including an ownership amount reflecting an ownership stake held by the investment fund entity in the portfolio operating company; and, an electronic representation of a portfolio investment entity, including operational and legal data about the portfolio investment entity for performing logical operations thereon, and an association with the electronic representation of the investment fund entity. The electronic representation of an investment fund entity may include detailed investment records corresponding to individual investments made by the investment fund entity in the portfolio operating company.

### CROSS-REFERENCE TO RELATED APPLICATIONS

This application claims priority under 35 U.S.C. § 119 to, and is a non-provisional conversion of, U.S. Provisional App. No. 63/123461, which is hereby incorporated by reference in its entirety for all purposes. As well, this application hereby incorporates by reference, in its entirety and for all purposes, U.S. Pat. App. Pub. No. 20160140462A1 and U.S. patent application Ser. No. 16/892,059.

### BACKGROUND

In private equity and venture capital fund management, investments are made using investment vehicles, which each typically are created as a new legal entity (“Fund X”). There are lots of sub-entities between the partners of the VC firm and the individual funds, Fund I, Fund II, etc., with complicated ownership, which in the past has been imperfectly modeled by computer systems.

Investment funds, including private equity funds, need various specific information in order to manage their operations and assess their performance, including: information rights management, board actions, stockholder actions, key holders. This info is very painful to obtain currently. Investment funds have staff doing this now, and they have to communicate to their limited partners. This is a pain point for the fund managers.

However, the Shoobx system collects, in the process of producing its interface, a great deal of this information fund managers care about. Therefore, using this information, Shoobx has come up with the disclosed system and method for providing investment entity and fund management tools.

The disclosed system has the capability, disclosed herein and in the documents incorporated by reference herein, to represent entities and persons using electronic records; these entities can have relationships with each other; equity financing is also enabled to be represented electronically in the system. A package of legal agreements from the NVCA (National Venture Capital Association) may be provided for use by users, including: Stock purchase agreement; Voting agreement; Information rights agreement; ROFR (right of first refusal) agreement; Restated cert of incorporation. A workflow is contemplated to be developed such that the information collected enables a user interface and views into the data, as well as triggering of workflows, such as enabling creation of a PDF report, etc. for the portfolio investors of a venture fund or of a venture capital firm.

### SUMMARY

A system for investment entity management is disclosed. In a first embodiment, at least one database is configured to store: an electronic representation of a portfolio operating company, the portfolio operating company being a legal business entity, the electronic representation of the portfolio operating company including detailed ownership records of the portfolio operating company; an electronic representation of an investment fund entity for investing in one or more portfolio operating companies, including an association with the electronic representation of the portfolio operating company and an ownership amount reflecting an ownership stake held by the investment fund entity in the portfolio operating company; and, an electronic representation of a portfolio investment entity (PIE), including operational and legal data about the portfolio investment entity for performing logical operations thereon, and an association with the electronic representation of the investment fund entity. The electronic representation of an investment fund entity may include detailed investment records corresponding to individual investments made by the investment fund entity in the portfolio operating company.

The system may further comprise a business logic module configured to compute each of: a present valuation of the portfolio operating company; a present ownership fraction derived from the ownership amount stored in the electronic representation of the investment fund entity; and, a present valuation of the ownership stake held by the investment fund entity in the portfolio operating company based on the present valuation and the present ownership fraction. The detailed investment records corresponding to individual investments made by the investment fund entity in the portfolio operating company may include a stock share class, a number of shares, an amount invested, and a date of transaction. Investment fund investment classes may also be tracked.

The system may further comprise a user interface module configured to display or output a chart showing a percentage allocation of each of a plurality of portfolio operating companies in the investment fund entity, and, to display a tabular view showing the percentage allocation. The system may further comprise a user interface module configured to display or output a chart showing a present value of each of a plurality of portfolio operating companies in the investment fund entity, and, to display a tabular view showing the present value. The system may further comprise a user interface module configured to display or output a future scenario planner with one or more of editable growth estimates and projected future decision points. The system may further comprise a user interface module configured to display or output a chart showing investments in one or more portfolio operating companies across a plurality of investment fund entities, based on associations stored within the electronic representation of the portfolio investment entity. The system may further comprise an authentication module configured to permit a person associated with the portfolio investment entity to view, edit, and operate on data of the electronic representation of the investment fund entity for which the person may be granted access. The system may further comprise a delegation manager configured to perform authorization to perform an action in the system using one or more or permissions, roles, principals, or groups, and configured to permit principals to delegate a permission or role to another principal in the context of a particular investment fund entity or portfolio investment company.

In a second embodiment, a method for investment entity management is disclosed, comprising: storing, in a database, an electronic representation of a portfolio operating company, the portfolio operating company being a legal business entity, the electronic representation of the portfolio operating company including detailed ownership records of the portfolio operating company; storing, in the database, an electronic representation of an investment fund entity for investing in one or more portfolio operating companies, including an association with the electronic representation of the portfolio operating company and an ownership amount reflecting an ownership stake held by the investment fund entity in the portfolio operating company; and, storing, in the database, an electronic representation of a portfolio investment entity (PIE), including operational and legal data about the portfolio investment entity for performing logical operations thereon, and an association with the electronic representation of the investment fund entity, The electronic representation of an investment fund entity may include detailed investment records corresponding to individual investments made by the investment fund entity in the portfolio operating company. The method may further comprise computing each of: a present valuation of the portfolio operating company; a present ownership fraction derived from the ownership amount stored in the electronic representation of the investment fund entity; and, a present valuation of the ownership stake held by the investment fund entity in the portfolio operating company based on the present valuation and the present ownership fraction.

In a third embodiment, a non-transitory computer-readable medium is disclosed that, when executed on a computer, performs operations comprising: storing, in a database, an electronic representation of a portfolio operating company, the portfolio operating company being a legal business entity, the electronic representation of the portfolio operating company including detailed ownership records of the portfolio operating company; storing, in the database, an electronic representation of an investment fund entity for investing in one or more portfolio operating companies, including an association with the electronic representation of the portfolio operating company and an ownership amount reflecting an ownership stake held by the investment fund entity in the portfolio operating company; and, storing, in the database, an electronic representation of a portfolio investment entity (PIE), including operational and legal data about the portfolio investment entity for performing logical operations thereon, and an association with the electronic representation of the investment fund entity, The electronic representation of an investment fund entity may include detailed investment records corresponding to individual investments made by the investment fund entity in the portfolio operating company. The operations may further comprise computing each of: a present valuation of the portfolio operating company; a present ownership fraction derived from the ownership amount stored in the electronic representation of the investment fund entity; and, a present valuation of the ownership stake held by the investment fund entity in the portfolio operating company based on the present valuation and the present ownership fraction.

### BRIEF DESCRIPTION OF THE DRAWINGS

FIG. 1A is an overview screen, in accordance with some embodiments.

FIG. 1B is an exit projection screen, in accordance with some embodiments.

FIG. 2 is a company detail screen, in accordance with some embodiments.

FIG. 3 is a company financial history screen, in accordance with some embodiments.

FIG. 4 is a corporate information edit screen, in accordance with some embodiments.

FIG. 5 is an add investment screen, in accordance with some embodiments.

FIG. 6 is a schematic diagram showing roles and permissions in the system, in accordance with some embodiments.

FIG. 7 is a schematic diagram showing a logical organization, in accordance with some embodiments.

FIG. 8 is a schematic diagram showing a computer system, in accordance with some embodiments.

FIG. 9 is a schematic diagram showing operation of a business operating system, in accordance with some embodiments.

### DETAILED DESCRIPTION

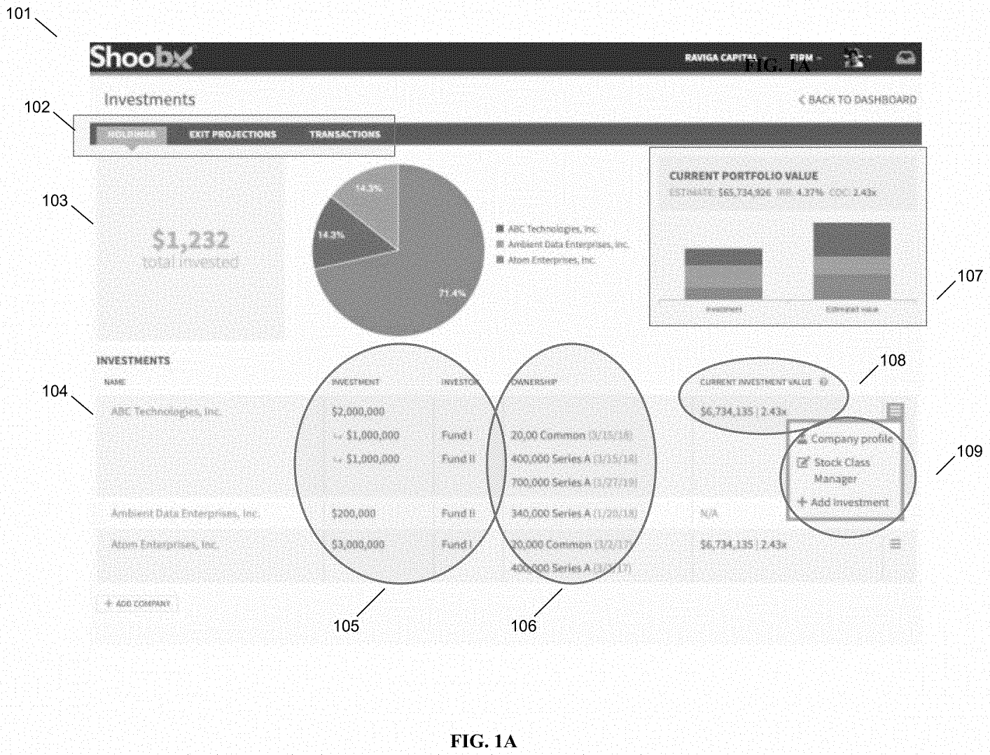

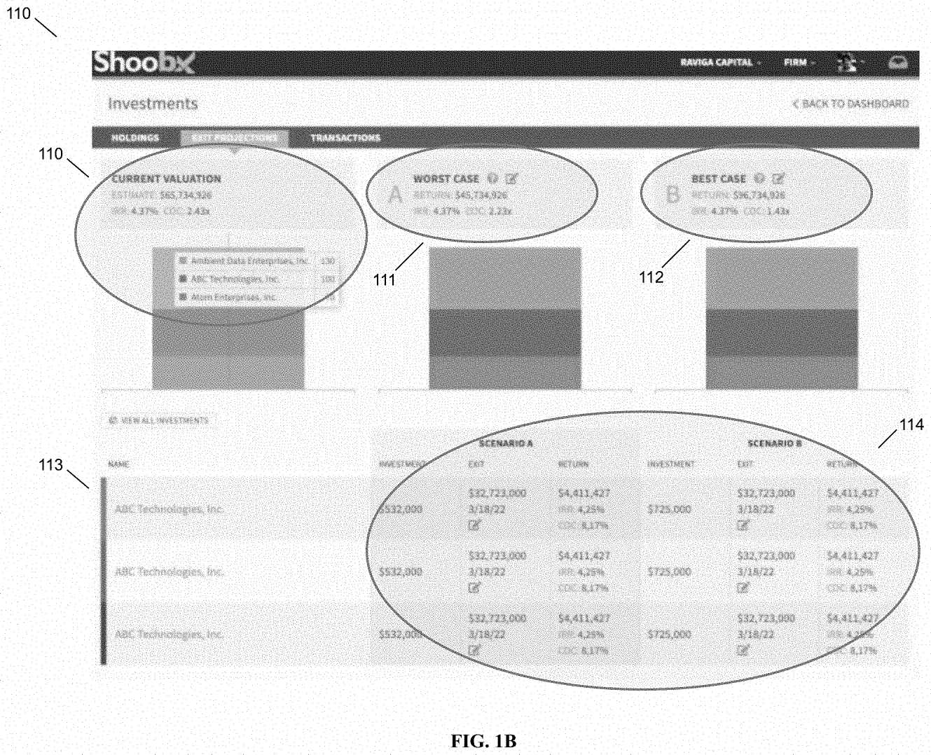

FIG. 1A is a schematic user interface 101 showing investments in a fund. At the top of the screen are three tabs 102, providing three views of an investment fund: macro; exit projections; and, micro. A tab bar provides access to three screens corresponding to the three views. The macro view is labeled “holdings,” in some embodiments. The micro view is labeled “transactions,” in some embodiments. The macro view is shown in further detail in the present figure, e.g., FIG. 1A. The exit projections view is shown in FIG. 1B.

In the macro view (“holdings”), a chart view 103 shows one or more charts that provide information about the entire investment fund, which may include, in some embodiments: a percentage allocation of each company in the investment fund's portfolio; a tabular view 104 showing allocation of each company in the portfolio, along with current investment value and ownership structure, with investments being shown per fund or across multiple funds, in some embodiments; a chart view 107 of current portfolio value, juxtaposed with a chart view of initial (invested) value of the investment fund, in some embodiments. The investments are shown in a table view 105, 106, 108 that provides detailed information to the fund manager, which may include, in some embodiments, one or more of: the amount of an investment at the time it was made; the date of the investment; the class of stock and number of shares of the investment; the firm investment class; the fund that served as the investment vehicle for the particular investment; the current value of the investment or other metrics comparing the present value of the investment against the original value of the investment, such as multiple and IRR. In some embodiments, each investment is recorded in the system with each of the parameters listed in the preceding sentence, except for the computed current value and other metrics. In some embodiments, a list of specific shares purchased in each past round of investment is shown, which in some embodiments may be driven by underlying documents in the system. In some embodiments, a dropdown menu 109 is provided for view and/or edit access to a company profile, a stock class manager, an add investment screen, or other features pertaining to a particular operating company (i.e. table row). In some embodiments, the class of stock or the class of investment fund may be based on documents (core records) held elsewhere within the system. The system also tracks classes of stock as they are created and changed over time, based on the underlying legal documents, in some embodiments, and may use this to generate the table view and to perform valuation analysis.

Having information about which investment vehicle made which investments is valuable for the investment fund manager, and having information about all historical investments in a portfolio company also shows the fund manager an aggregate view of all interactions that the private equity firm has with the particular portfolio company. Each entity (fund, operating company, private equity firm) is represented in the system with associative relationships, in some embodiments, so that all funds that belong to the private equity firm can be identified, and all companies invested in by a particular private equity firm can be identified, for example. Operational and legal data such as the names and identities of individuals who are directors or partners of the private equity firm are also represented, and access controls are able to be provided to each person according to the legal rights that such person has, in some embodiments. As additional investments are made over time, the fund manager can keep the software up to date manually (by adding each investment transaction individually with all necessary parameters) or automatically (using a system, like the Shoobx system, to initiate and execute investments in such a way that the investment transactions are made available to the transaction data store of the present disclosure), and all investments in the system can be represented using the data view in FIG. 1A.

In the micro view (“transactions”), investments are shown at the granularity of individual fund transactions in a table view (not shown), which are backed by the underlying data store because the underlying data store contains annotated contracts that include relevant information from each investment transaction. The relevant information may include, in some embodiments, parties to the transaction; an investment amount; a date of the transaction; and/or other information specified in the contract for each investment transaction. The relevant information includes, in some embodiments, a Portable Document Format (PDF) or other electronic copy of the executed contract. The relevant information also includes, in some embodiments, authenticated electronic signatures of the executed contract.

FIG. 1B is a schematic user interface 110 showing an exit scenario planner, in accordance with some embodiments. The exit scenario planner presents three scenarios or another number of scenarios, which may be specified or modified at the direction of the user, which is an investment manager at the private equity firm, in some embodiments. As shown, three scenarios are shown for the present investment, which may be a particular investment fund. The investment fund includes investments made into multiple operating companies, which are tracked on a per-transaction basis in the system. The scenario planner allows detailed exit calculations that take into account different performance of different investments, date of entry and exit, and up-to-date valuation data.

In the exit scenario planner view, the individual investments are aggregated into a single number reflecting the total amount of the investment in a particular operating company, in some embodiments. The amount of the investment is shown together with a user-editable exit amount and date, reflecting the amount and date that the fund manager desires to model. Based on the initial investment, which is tracked by the system and includes its amount and date, and the time to exit, the exit scenario planner view may compute various metrics characterizing the return on investment in that particular operating company, such as internal rate of return (IRR) or cost of capital (CoC), in some embodiments. The investment amount is editable on a per-scenario basis, to enable a fund manager to model a scenario where the manager makes a follow-on investment, in some embodiments. An edit glyph is used to show the fund manager what parameters can be edited for scenario planning, in some embodiments. Multiple operating companies can be represented. Multiple scenarios are also able to be accommodated. All the investments in a particular fund are rolled up into charts, one chart per scenario, and the scenarios are shown as charts together with metrics, as shown at the top of FIG. 1B 110, 111, 112. A table view is shown with names of operating companies in different table rows, and with columns reflecting an investment amount (dollars in), exit, and return for different scenarios, 114. In some embodiments a glyph is used to indicate that a particular operating company is fully represented and tracked in the Shoobx system, as with the bottom-most operating company in FIG. 1B. In FIG. 1B, a current valuation 110, a “worst case” scenario A 111, and a “best case” scenario B 112 are shown in the scenario planner. Names of the scenarios may be editable, in some embodiments. Additional investment, such as follow-on investment, may be tracked and shown with additional labels as shown in FIG. 1B, in some embodiments.

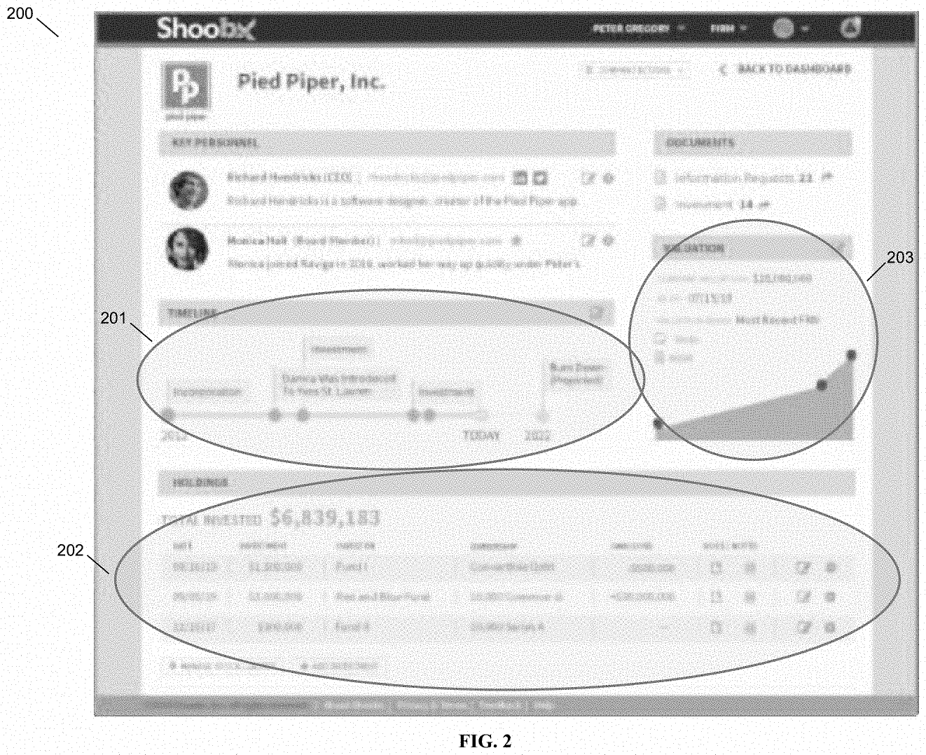

FIG. 2 is a schematic user interface 100 showing a data view of information that is stored in the system regarding a particular operating company, in accordance with some embodiments. A single operating company may be the subject of multiple investments. Using the data view shown in FIG. 2, the multiple investments can be shown in a tabular view 202 that allows for detail to be presented on each investment. As well, aggregate data can be presented across all the investments, such as the total invested as shown here, or the total valuation at the present time, or metrics regarding current valuation versus amount invested. In the tabular view, add, edit, and/or delete functionality can be exposed via buttons and free-form notes can be permitted to be added by the fund manager. The type of stock or ownership, investment vehicle (e.g., investment fund) and the dollar amount at the time the investment was made can be shown for each investment, in some embodiments. A timeline view 201 can also incorporate freeform notes or manual date-synced entries, as shown in the present FIG. 2 (“Danica was introduced to Yves St. Lauren”), in some embodiments. As well, as investments are made over time, information can be shown in a timeline view. Investments can be shown in a valuation timeline view or historical chart of valuation 203. Certain data entries in one or both of a numeric or non-numeric timeline view may be generated automatically via system-stored data.

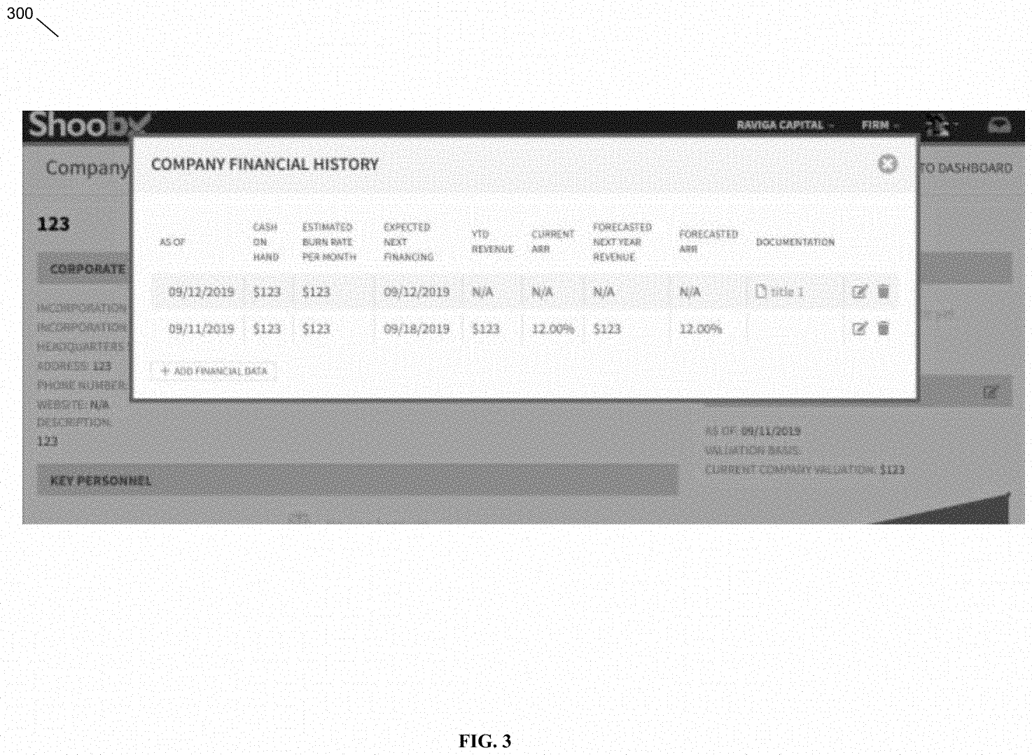

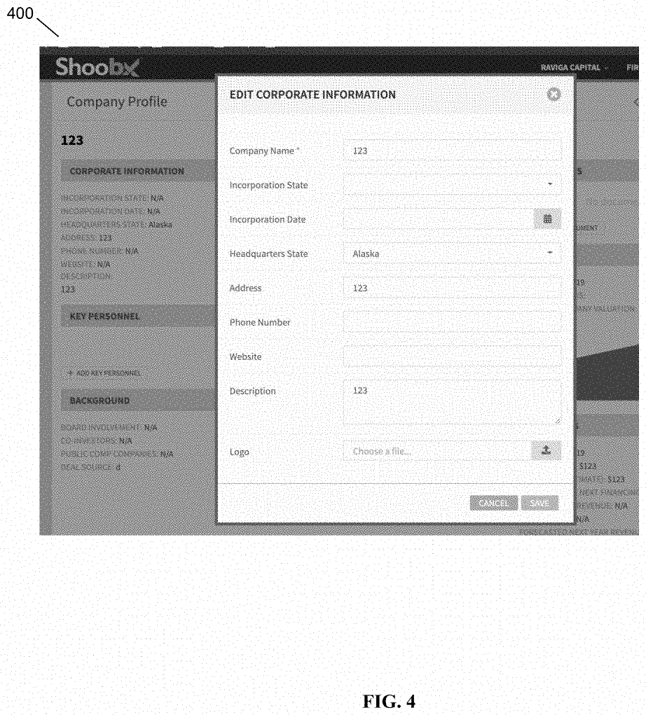

A company profile screen is disclosed as follows. The company profile includes a great deal of information that is collected by the Shoobx system: a list of investments (the fund's investments in the company, and/or, investments that the fund has the right to know about); Key personnel—the system will suggest but you can add your own; financials: financial history, cash on hand, burn rate, expected next financing, ARR, revenue, etc. FIG. 3 shows a company financial history 300 in a table view. FIG. 4 shows an edit screen 400 for editing corporate information that is not based on other documents stored by the system or not otherwise known to the system.

The financials may be: Manually tracked by investor fund; Derived from the system for some items; and/or Editable, for companies that are not on the system. The intent being, every quarter, this information will flow to the investor automatically because this information is in the system. The system may include all this information in the case that: we have the investment documents. The investment rights documents require the financials. This enables the system to auto-create a workflow for the company to create the information and put it in the system. Company pushes this information to all the investors; this is one of the key savings of time and effort, both to the company and for the investors, who don't have to inquire.

More generally, there may be an investor rights agreement that lists everything the investor is supposed to get. This agreement may be stored in the system, in some embodiments, and in some embodiments may be used for the metadata for the information rights. We know what time which investor has rights to what information; Based on these core records, we can pass along that information or request that information. Other types of information is in the system and may be used to generate key investment reports: number of employees; who is on the board; key employees; updated cap table; how many shares issued from the authorized pool.

Creating a workflow, based on the investment documents, for requesting financials, is thus hereby disclosed. Scheduling these workflows; scheduling the disbursement of this information is also contemplated. By utilizing the metadata encoded in the information rights agreement document, we are now using that information to automatically flow data through to the investor.

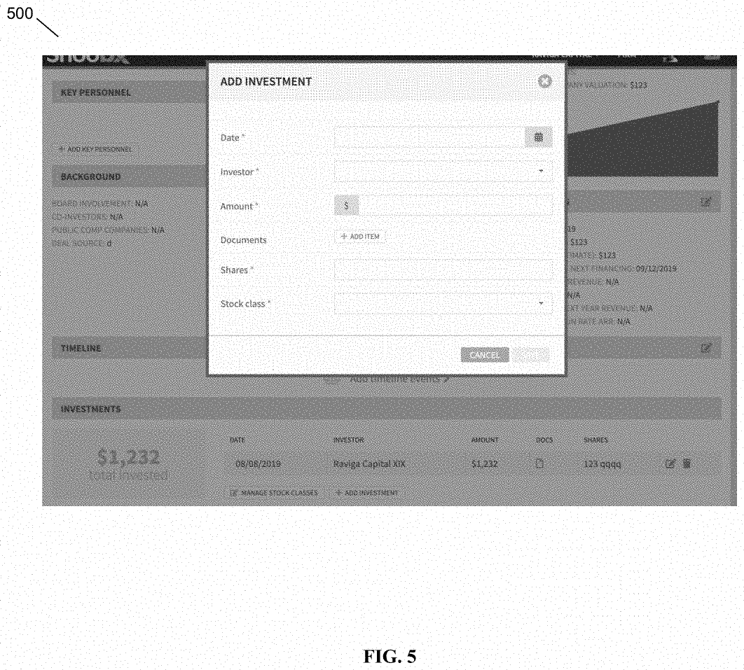

FIG. 5 shows an add investment screen that requests the user to manually enter in, e.g., date of investment, investor (e.g., which investment vehicle or fund made the investment), the amount of the investment, the number of shares and the stock class, and to substantiate with documents. Alternatively, the system may provide workflows based on annotated legal documents that allow this information to be collected directly by the system while the system facilitates the dissemination of documents, obtention of signatures and/or transfer of funds required for the investments to be made, according to the workflows described elsewhere herein and in the documents incorporated by reference herein.

Valuation may be calculated by the system, in some cases using 409A valuations, in others a per-share price of common, in others a book value calculated using cash on hand/assets/liabilities or otherwise derived from financial filings. This is complex and depends on the entire liquidation stack and stock class information. In the simplest path, golden path, positive—convert everything to common to come up with this current investment value. In the negative situation, use the liquidation stack to convert with precision who gets paid out first. Whenever the valuation is less than the amount invested, for example. The system the relevant info and we can do that immediately to zero out any investments that are worth $0 due to the liquidation stack.

Various visualizations are contemplated and shown, including at least: Pie chart (showing amount invested, or other charts); Stacked bar (Shows both amount invested and estimated value); burndown chart based on cash on hand including investments and revenue.

In some embodiments, a user at a venture capital firm may want to be able to group by just Fund I, Fund II, etc. There are two dimensions, fund and company. The current screenshot shows “Group by company”; we support “group by fund” also. The visualizations allow for answers to questions such as: What is my 5-year performance? What is my performance for 2017 investments? etc. If you worry about Fund I performance, you can see that. In the case of Angel investor funds, where a single fund includes a larger number of companies, more featureful rollup and filtering and drill-down functionality may be provided.

In some embodiments, exit projections are enabled. Three projections are shown in the figures: Current valuation; Worst case; Best case. Using the edit button, we require the user to enter two values: valuation amount and date. These two scenarios are shown next to each other, providing unprecedented overview and insight. Note that the equity structure and liquidation stack being modeled is only as good as the model, which in the case of the disclosed system is superior and has extreme fidelity. Shown: IRR (internal rate of return), COC (cash-on-cash return), return. This enables estimating when a company will exit at what value. A selector is present for per-fund performance, overall total performance, temporal performance. By clicking edit on a company, you can show the exit scenario planner for each company, described in U.S. patent application Ser. No. 16/892,059 and hereby incorporated by reference in its entirety for all purposes. In the case that Company A is doing well, company B is doing poorly, and we can model that. Color represents an individual company; the legend is built into the table.

A transactions screen is disclosed, in some embodiments, showing at least a flat list of documents—a helpful report for SEC filings. This is a list of transactions they did, over their own portfolio. It can be any reports derived from the underlying data for legal and information rights compliance. It can be aggregated off of investments, per fund, by year, by any grouping.

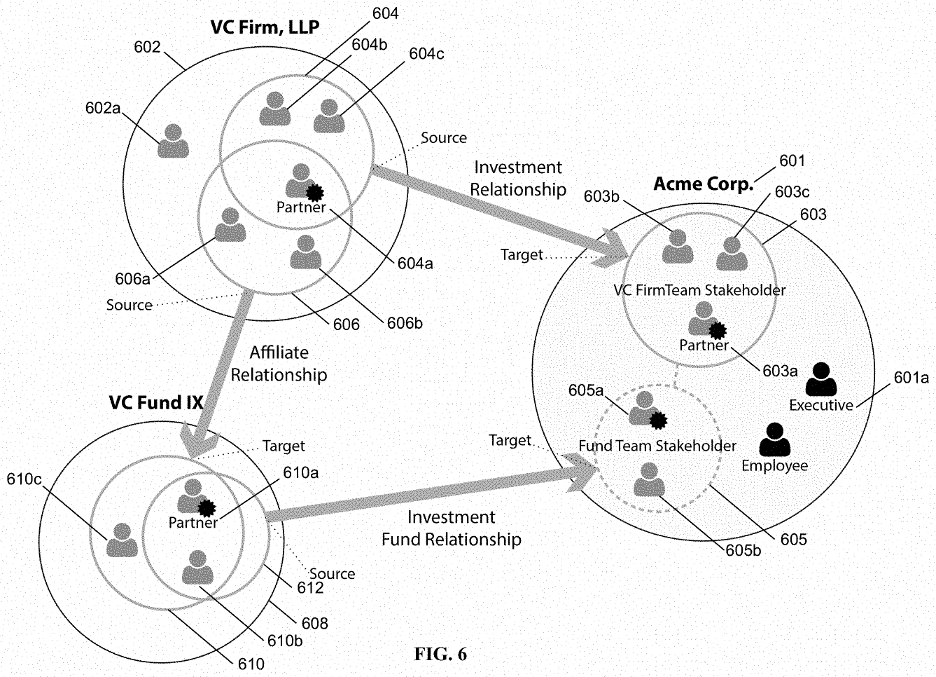

FIG. 6 is a schematic diagram showing roles and permissions in the system, in accordance with some embodiments. Shown is a schematic diagram of a relationship between an investment firm, a company, and another entity, in accordance with some embodiments. Acme Corp. entity 601 includes CEO 601a, VC firm team stakeholder 603, and VC fund team stakeholder 605. VC firm entity 602 includes relationship team 604 and relationship team 606. VC firm entity also includes VC partner 602a, who is not involved with Acme Corp; VC partner 604a, who is involved with Acme Corp and is the primary contact; associates 604b and 604c, who are involved with Acme Corp; and associates 606a and 606b, who are involved with VC fund entity 608. VC fund entity 608 includes relationship team 610, which includes primary contact/partner 610a and associates 610b and 610c, and relationship team 612, which includes primary contact/partner 610a and associate 610b. VC firm team stakeholder 603 includes primary contact 603a and team members 603b and 603c. Primary contact 603a is enabled to have access rights to Acme Corp 601 within the context of VC team stakeholder 603. VC fund team stakeholder 605 includes persons 605a and 605b. Person 605a may be a primary contact for team stakeholder 605 and is enabled to have access rights.

The relationship between Acme Corp. 601 and VC firm 602 can be described as an investment relationship. However, private equity and venture capital firms generally invest their money in companies indirectly, through entities that are set up individually for each fund. In order to model this type of relationship properly in the disclosed system, an investment fund is enabled to be modeled as its own independent entity, here VC fund IX 608. Also, as it is preferable for a user of the system, either an executive of Acme Corp 601 or a partner in VC firm 602, to see the investment as being an investment by the VC firm and not by the fund, the two entities 603 and 605 may be coalesced by the business logic or user interface logic of the system so that a user sees the VC firm as the only entity and does not see the VC fund entity, in some embodiments, except when it is desired to see the VC fund entity itself. Coalescing certain relationships in this way enables the system to model these relationships without the use of chaining relationships, such that only one level of relationship is required to be implemented in the system.

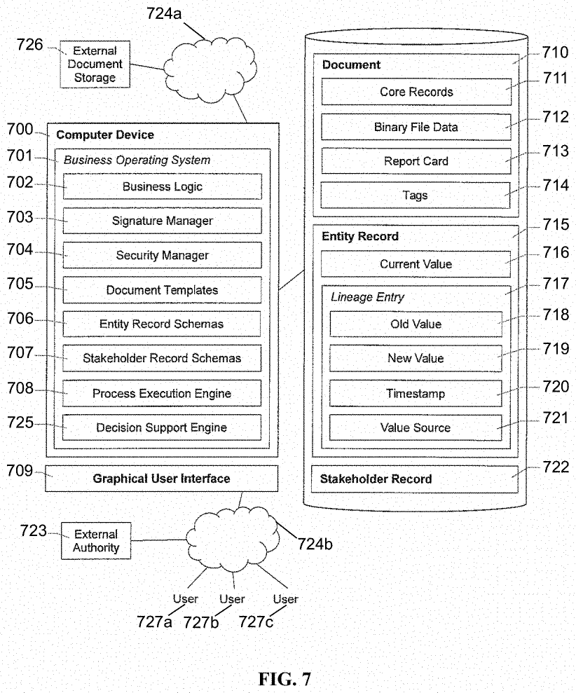

FIG. 7 is a schematic diagram showing a logical organization, in accordance with some embodiments. Application server 700 may be an application server, or a group of application servers, such as the app tier 103 shown in FIG. 1. Application server 700 includes a business operating system 701, which further includes business logic 702, signature manager 703, security manager 704, document templates 705, entity record schemas 706, stakeholder record schemas 707, process execution engine 708, and decision support engine 725. Business logic 702 may be one or more business processes, configured to be executed by process execution engine 708. Examples of a business process are: incorporation; nomination of a board; creating board resolutions; creating a stock plan; granting stock to an employee; and identifying a consultant or an employee, among other examples. Signature manager 703 may provide functionality and services for storing electronic signatures, retrieving prior-stored signatures, and reading and writing quick response (QR) codes. Security manager 704 may provide functionality pertaining to the security of the system, such as logging, transaction monitoring, authentication and authorization, auditing and reporting, as well as interfacing with third-party security functionality and services.

Document templates 705, entity record schemas 706, and stakeholder record schemas 707 provide the framework for data to be stored on the system. Document templates 705 provide templates for a variety of types of documents. As the documents are intended to be legal documents for a company's business processes, some or all of the document templates may be authored by attorneys according to state and federal law, with particular attention to Delaware corporate law. The document templates may be predefined and inalterable, or they may be alterable such that a company may make changes to the document templates by uploading new templates, or the document templates may be individually alterable. The entity record schemas 706 may include schemas for various types of corporate entities, such as S-corporations, C-corporations, limited liability corporations and partnerships, and may include parameters such as state of incorporation, address of incorporator, address of corporation, primary address, board membership, corporate structure, and other parameters. The stakeholder record schemas 707 may define a stakeholder as a person within the context of the entity, with contact information for the person such as address, email address, and phone number(s), and may also define a stakeholder as having one or more roles, such as board member, board secretary, shareholder, corporate officer, or other roles. A single stakeholder may hold more than one role; a user may also hold one or more roles for one or more corporate entities.

Decision support engine 725 may provide analytics for real-time reporting during the execution of a business process, based on data available to the business operating system. For example, if multiple people known to the business operating system have the title “Chief Engineer,” the system may be able to compute basic analytics on this set of people to provide information regarding their average and median salary, stock compensation, etc., in real time such that at the time a new hire contract is being created on the system, the relevant information is provided to the user. Decision support engine 725 may rely on external document storage 722 for this information, and may also rely on business logic 702 and process execution engine 708 to determine when the decision support engine 725 may be invoked.

Application server 700 may interact with external document storage 722 via network 724a. In some embodiments, external document storage 722 may be for storing generated documents in binary format only, such that a user may be able to retrieve relevant legal documents at any time without use of the business operating system 701. The external document storage provider may be, for example, Box.com, Dropbox, Google Drive, a private WebDAV file store, or any other cloud-based content storage solution. In other embodiments, external document storage may be used for storing all information, including information formatted according to document templates 705, entity record schemas 706, and stakeholder record schemas 707. Application server 700 may also interact with external authority 723 and users 725a, 725b, 725c via network 724b. An external authority 723 may be provided for authenticating users on the system. For example, an external authority may provide two-factor authentication support such that a user may be authorized by the external authority before being granted access to business operating system 701. Graphical user interface 709 may provide a visual interface to business operating system 701; the user interface 709 may appear in a web browser and may combine results and outputs from multiple parts of business operating system 701 into a single outputted HTML page. In some embodiments, the HTML page may contain functionality as well, such as input validation functionality performed in JavaScript, in order to provide higher-quality data to the underlying system.

Document 710 includes core records 711, binary file data 712, report card 713, and tags 714. Entity record 715 includes current value 716 and lineage entry 717, which includes old value 718, new value 719, timestamp 720, and value source 721. Stakeholder record 722 is also shown. Each of the above data objects is stored in a database at a database server, and may be stored in a relational database, such as PostgreSQL, in a non-relational manner, such as in the JSONB format. In some embodiments, data elements may comprise references to other data objects. For example, the binary file data 712 in document 710 may be actual binary file data stored in a database, or may be a reference to binary file data stored outside of a database, for example, as a uniform resource indicator (URI) indicating the location of a file accessible via HTTP from another server. Also, the value source 721 that is part of lineage entry 717 may be a reference to another object, such as another document object, and may not be the object itself. In some embodiments, an array of lineage entries may be stored in entity record 715.

Document 710 is intended to permit multiple core records 711 to be associated with the document. For example, a certificate of incorporation would have at least a core record for the company's address and another core record for the founders of the company. In some embodiments, the report card may or may not be present; when present, the report card may be updated at the time the document object is saved or at a later time based on when processing resources are available for calculating the trustworthiness of the data associated with the document. In some embodiments, a single binary file data object 712 is associated with one document object 710. Documents may be associated with entity records as well, in some embodiments,

In some embodiments, tags 714 are free-form text and may be human-readable. Multiple tags may be associated with a single document. In some embodiments, the tags may have a hierarchical structure to facilitate search and retrieval. Certain tags may be special; for example, the “active” tag indicates to the system that a document is legally in effect, and may be automatically updated when a new document is created or when an older document is superseded; also, entity records may be associated with documents as tags, in some embodiments. Superseding of a document may be quickly determined by the system performing a search for the type of document, e.g., “stock option plan,” to find all documents with a particular type for a particular entity record.

In some embodiments, an entity record 715 may include both a current value 716 and a lineage entry 717. Although an entity record contains a current value 716, the entity record's current value 716 duplicates the value stored in the lineage entry. This facilitates retrieval of the value without dereferencing any references in the lineage entry, and may be thought of as a cached value. Lineage entry 717 includes at least a value source 721, to indicate that the lineage of the current value is originally from that other object. Lineage entry 717 may also include old value 718, which is the value that was previously stored in the entity record; new value 719, which is the same as the current value 716 and the value of that entity in value source 721; and a timestamp 720. Current value 716 may be thought of as a cached value. Current value 716 points to an up-to-date value of the core record, even if the core record has been modified.

Value source 721 may be a reference to another object, such as a document. For example, if a stock option plan was put into place at a prior date, the number of authorized shares of a corporation would be determined by the active stock option plan document, so although the entity record for the corporation would include the number of shares of the corporation, it would also indicate that the number of shares originated in the active stock option plan document. An auditor would thus be able to determine the source of the number of shares upon later review.

In some embodiments, a value source 721 may be a stakeholder record and not a document. This may occur when a value is manually entered without reference to a prior document, or when a document is uploaded and does not contain generated values in the system.

In some embodiments, stakeholder record 722 may include one or more roles (not shown), as well as basic information about the stakeholder, such as name, address, phone number, email, and so on (not shown). A role indicates what actions that may be performed or initiated by the stakeholder.

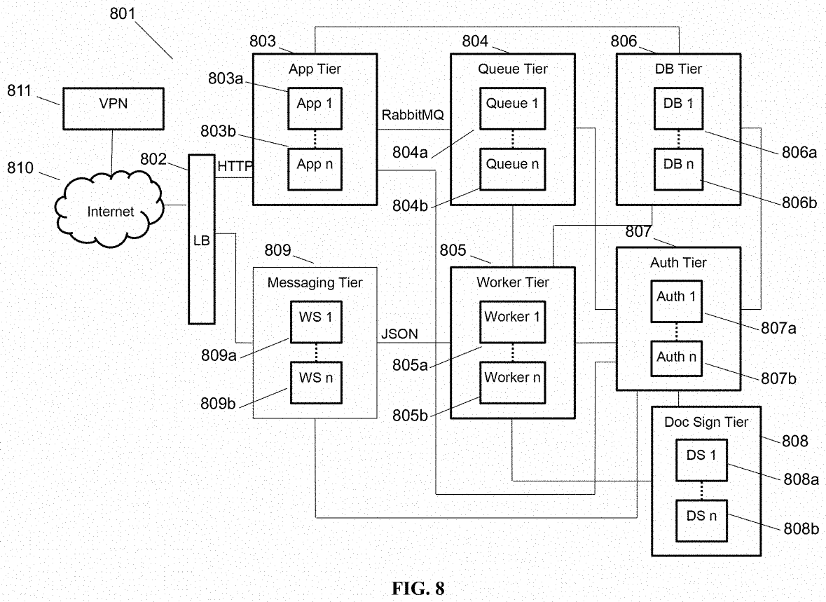

FIG. 8 is a schematic diagram showing a computer system, in accordance with some embodiments. Business operating system platform 801 may include load balancer 802, app tier 803, queue tier 804, worker tier 805, database tier 806, authentication tier 807, document signing tier 808 and messaging tier 809. Each tier may include one or more servers that may be virtual servers or physical servers. The servers may be activated or deactivated as needed based on load parameters that may be determined by the business operating system, wherein the load parameters include CPU load and network bandwidth utilization.

Load balancer 802 acts as a gateway between the remainder of platform 801 and the public Internet, in some embodiments. Load balancer 802 also may allocate incoming requests among servers in app tier 803. In some embodiments, an HTTP load balancer such as nginx may be used.

App tier 803 includes one or more web servers 803a, 803b for receiving web requests via Hypertext Transfer Protocol (HTTP), in some embodiments. The web servers may then determine what tasks, if any, need to be distributed to either a database tier 806 or a queue tier 804. The web servers may then return fully- or partially-rendered web pages to a requesting web browser. As the web browsers are behind load balancer 802, different servers may service different web requests. In some embodiments, the web servers may be web application servers, and the applications running on them may be precompiled, linked at runtime, Common Gateway Interface (CGI) applications, modules executed by a web server process, or otherwise executed. The web servers may also integrate their own load balancing, in some embodiments. In some embodiments, load balancing may occur only at 802, only at 803, or at neither, or both points in the system.

The queue tier 804 and the worker tier 805 may include one or more servers, and may include a facility to activate or deactivate servers as needed to meet the needs of the service, in some embodiments. The queue tier 804 may receive requests from the app tier 803 and may identify sub-tasks, which may then be sent to worker tier 805 to be executed. The queue tier 804 may use a queuing messaging protocol such as RabbitMQ for assigning tasks to processes at the worker tier, in some embodiments. The queue tier 804 may use the Celery queuing software with well-known queuing algorithms to provide reliable service.

The worker tier may execute sub-tasks, such as rendering documents, executing processes, requesting data from database tier 806, and sending emails, in some embodiments. The sub-tasks may execute at the worker tier as threads, processes, or via another processing abstraction that is capable of being processed in parallel. The sub-tasks may involve one or more requests for data from other servers or network nodes. Rendering documents may cause portions of documents to be rendered to text, Hypertext Markup Language (HTML), partial HTML (HTML snippets), JavaScript, JSON, Portable Document Format, the ReportLab report markup language (RML), or another format. Rendering documents may also involve combining data stored in core records with data stored in or generated by document templates, as described above. In some embodiments, reports, including reports generated by ReportLab from RML, and including audit reports and logs, may be generated. In some embodiments, documents may be generated based on user input and then sent back to the app tier 803 for authentication by the authentication tier 807.

Execution of processes may involve the use of processes stored as eXtensible Markup Language (XML), XML process definition language (XPDL) workflows, or other data that define the process, and may involve the creation of or modification of entity records, core records, stakeholder records, or other records. Emails may be sent by the worker tier to, for example, send reminders about approaching deadlines or to send password reset messages. When worker tier 805 completes work and/or receives an appropriate response from one or more other servers, it sends a message, which may be HTTP JSON, to a messaging tier 809, which is responsible for assembling a reply and sending it back to a requesting user via load balancer 802.

Database tier 806 may receive requests for data from worker tier 805, and may retrieve information stored in the form of one or more core records, entity records, or stakeholder records. Data may be written to one or more databases as serialized JSON objects. The database tier 806 may use a database that enables JSON storage, such as PostgreSQL 9.4 or above using the JSONB data type. Data from multiple entities may be distributed across database servers in various ways. In some embodiments, all data for a particular corporate entity may be placed on a single database server, enabling sharding of large databases on a per-entity basis and providing added security for each entity. Data may be requested from the database tier by a worker tier or by the app tier directly. When data is needed to perform a task or sub-task, in some embodiments, the worker tier may cause data to be retrieved from the database tier. In other embodiments, the queue tier may create data retrieval requests from the database tier, or both the queue tier and the worker tier may send requests to the database tier. When data is created by the worker tier, for example, an HTML snippet, a complete PDF file, or a new or modified entity record in a corporate entity, data may be sent to and stored in the database tier 806 as JSON. In some embodiments, a cache or alternative data structure server such as memcached or Redis may be used for improving the read/write performance of database tier 806.

Also shown are authentication tier 807 and document signing tier 808. Authentication tier 807 serves to identify whether the logged-in user has the proper credentials to perform a particular process or sign a particular document. Authentication tier 807 may use the lightweight directory access protocol (LDAP) within an organization, or using an LDAP server (not shown), to authenticate a user. Authentication tier 807 may use the Red Hat FreeIPA suite, which includes LDAP, for managing identity, policy, and audit functions, including for keeping an audit log. Authentication tier 807 may also use Kerberos to permit users and other nodes securely prove their identity, or to securely prove the identify of the platform to external providers. Authentication tier 807 may permit the use of two-factor authentication. Document signing tier 808 may be responsible for communicating with a third-party system, such as Global Sign, to cause the third-party system to use a root-authenticated certificate to cryptographically sign the document after it is finalized, using Adobe Certified Document Services (CDS), to prevent modification of the document. The cryptographically-signed document may be saved to database tier 806 as a PDF associated with a document object.

Document signing tier 808 may use a Java library to communicate with a secure signing service located at an external network provider. Document signing tier 808 may include modules for interpreting both Java and JSON, for communicating with services internal to system 801.

One or more of the above application servers, web servers, load balancing servers, database servers, or other servers may be running a Linux operating system. In some embodiments, when used in a production role, the servers may be configured to have a minimum of services active, excepting only the specific services described above. This has the advantage of increased security, which is desirable when performing corporate processes and providing secure authentication services. In other embodiments, the servers may have additional active services. In some embodiments, a virtual private network (VPN) server 811 may provide the sole connection to the outside Internet for the system, thereby acting as a security gateway. In other embodiments, users may connect directly via network 810 to the system. Whether or not a VPN is used as a security gateway, access to applications may be limited through the load balancer as a gateway.

In some embodiments, one or more of the servers described may operate using the Linux operating system, and/or using an Ubuntu distribution of Linux. Various messaging protocols may be used between tiers, including for message passing; for example, RabbitMQ and Celery queuing and message passing middleware may be used. HTTP and JSON may be used as protocols for transmitting data. The web servers may use web applications written in Python in conjunction with a web server, such as the Nginx web server. Caching may be performed at one of the app tier, queue tier, or database tier using a web cache or object cache such as Redis. Servers as described herein may be virtual servers. Access to the platform may be partially limited to or solely through a virtual private network (VPN).

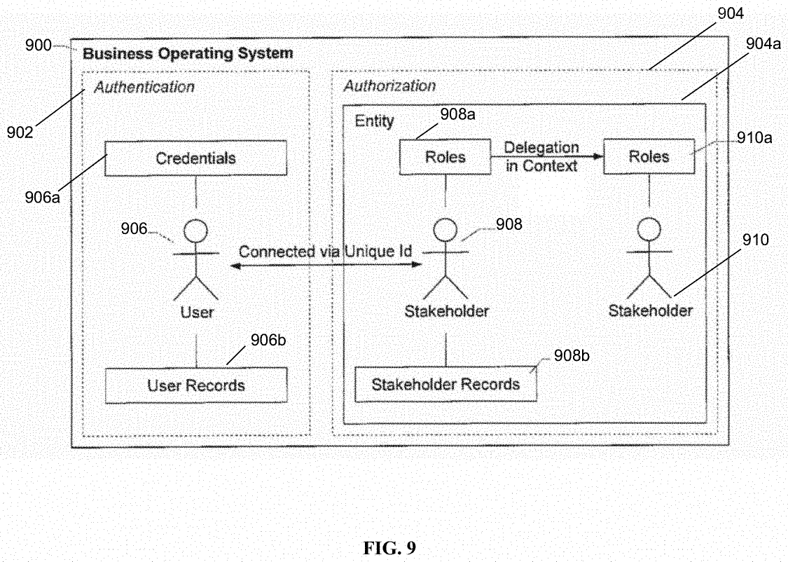

FIG. 9 is a schematic diagram showing operation of a business operating system, in accordance with some embodiments. Shown is a schematic diagram of users and stakeholders and their security roles, in accordance with some embodiments. Business operating system 900 includes an authentication module 902 and an authorization 904. Authentication module 902 is for identification of the user, e.g., is the user who he or she claims to be? Authentication module 902 includes credentials 906a and user records 906b for user 906. Authorization module 904 is for determining whether the specific user should be permitted to take a specific action, e.g., has the user been assigned the capability to perform this action? All records for the authorization module relate to at least one specific entity 904a; additional entities are not shown but may be present. Stakeholder roles 908a and stakeholder records 908b are associated with stakeholder 908. Additionally, stakeholder 908 may have received delegated roles 910a from stakeholder 910. Authorization module 904 also may determine what information the user has access to in the system. Authorization module 904 may use roles to determine what information, actions, or capabilities the user has access to.

In operation, user 906 may present his or her credentials to the system, which are matched against credentials 906a to verify the user's identity at authentication module 902. In some embodiments, two-factor or multi-factor authentication may be used. Once the user has authenticated, the user records 906b are retrieved by the system and all entities for which the user is a stakeholder are retrieved by the system as well, using the unique IDs for each user-stakeholder pair. Next, each user-stakeholder pair is evaluated for its roles 908a, 910a to determine whether a certain task is permissible. As each role includes permissions for many different actions and access to various information, role may be thought of as a keychain, containing many keys. In some embodiments, a context of the user on the system is taken into account in addition to roles (e.g., additional capabilities may be granted to a human resources user when the actions are performed on or from a human resources landing page, sub-site, or section of the user interface).

The foregoing discussion discloses and describes merely exemplary embodiments of the present invention. As will be understood by those skilled in the art, the present invention may be embodied in other specific forms without departing from the spirit or essential characteristics thereof. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and system can generally be integrated together in a single software product or packaged into multiple software products.

The above-described features and applications can be implemented as software processes that are specified as a set of instructions recorded on a computer-readable storage medium (also referred to as computer readable medium). When these instructions are executed by one or more processing unit(s) (e.g. one or more processors, cores of processors, or other processing units), they cause the processing unit(s) to perform the actions indicated in the instructions. Examples of computer readable media include, but are not limited to, CD-ROMs, flash drives, hard drives, RAM chips, EPROMs, etc. The computer-readable media does not include carrier waves and electronic signals passing wirelessly or wired connections. Code may be written in any combination of programming languages or machine-readable data formats, each suitable to its particular application, including but not limited to: C, C++, Java, Python, Ruby, R, Lua, Lisp, Scala, JSON, JavaScript, YAML, XML, HTML, etc. Services may be RESTful and may be implemented using generic hooks, including over HTTP, HTTPS, SCTP, IP, TCP, JSON, JavaScript, etc., as well as via inter-process communication on one or more real or virtual machines or containers, e.g., IPC, shared memory, shared filesystem, UNIX pipes and the like. A Linux or POSIX environment may be used. Containers may be Docker, Jetty, Tomcat, Wildfy, Springboot, LXD, unikernels, OpenVZ, RKT, Windows Server, Hyper-V, or any other type of container, or may be, in some embodiments, virtual machines or images, etc. Network access may be relied upon or may be avoided, in various embodiments. A networking fabric may be provided among the different containers, in some embodiments. As is well-known, the benefit of using cloud infrastructure is that it is simple to mix heterogeneous resources and to scale services up or down based on load and desired performance.

In the specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronics systems, define one or more specific machine implementations that execute and perform the operations of the software programs.

A computer program (also known as program, software, software application, script, or code) can be written in any form of programming language, including compiled or interpreted languages, declarative or procedural languages, and it can be deployed in any form, including as a standalone program or as a module, component, subroutine, object, or another unit suitable for use in a computing environment. A computer program may, but need not correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

These functions described above can be implemented in digital electronic circuitry, in computer software, hardware, or firmware. The techniques can be implemented using one or more computer program products. Programmable processors and computers can be included in or packaged as mobile devices. The process and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), readable compact discs (CD-R), rewritable compact discs (CD-RW), read-only digital versatile discs (e.g., DVD-ROM, dual-layer DVD-ROM), a variety of recordable/rewritable DVDs (e.g. DVD-RAM, DVD-RW, DVD+RW, etc.), flash memory (e.g., SD cards, mini-SD cards, micro-SD cards, etc.), magnetic or solid-state hard drives, read-only and recordable Blu-Ray® discs, ultra-density optical discs, any other optical or magnetic media, and floppy disks. The computer-readable media can store a computer program that is executed by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored in the circuit itself.

As used in this specification and any claims of this application, the terms “computer”, “server”, “processor”, and “memory” all refer to electronic or other technological devices. These terms exclude people or groups of people. For the purpose of the specification, the terms display or displaying means displaying on an electronic device. As used in this specification and any claims of this application, the terms “computer-readable media” and “computer readable medium” are entirely restricted to tangible, physical objects that store information in a form that is readable by a computer. These terms exclude any wireless, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, or any other available monitor types, for displaying information to the user and a keyboard and a pointing device, e.g., mouse or trackball, by which the user can provide input to the computer. Other kinds of devices can be used to provide for interaction with a user as well; for example, feedback provided to the user can be any form of sensory feedback, e.g., visual feedback, tactile feedback, or auditory feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication network include a local area network (“LAN”), an inter-network (e.g., the Internet), and peer-to-peer networks (e.g., ad-hoc peer-to-peer networks).

The subject matter described in this specification can be implemented using client-side applications, web pages, mobile web pages, or other software as generally known in the art and that would be usable to end-user customers (for community self-managed RAN apps) and/or mobile operator end users. The subject matter could alternately be delivered or implemented using an API, such as a SOAP API, a JSON API, a RESTful API, in lieu of or in conjunction with a direct end-user interface. The subject matter could use messaging queues, webhooks, server-side containers, or any other technology known in the art.

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purpose of displaying data to and receiving user input from a user interacting with the client device). Data generated at the client device (e.g., a result of the user interaction) can be received from the client device at the server. Any database could be used (SQL, NoSQL, temporal, key-value, etc.). Any container orchestration technology (Kubernetes, Docker Swarm) could be used.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in singular is not intended to mean “one and only one” unless specifically so states, but rather “one or more.” Unless expressly stated otherwise, the term “some” refers to one or more. Pronouns in the masculine (e.g., his) include the feminine and neuter gender (e.g., her and its) and vice versa. Headings and subheadings, if any, are used for convenience only, and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations or one or more configurations. A phrase, for example, a configuration may refer to one or more configurations and vice versa.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Accordingly, the disclosure of the present invention is intended to be illustrative of, but not limiting of, the scope of the invention.

1. A system for investment entity management, comprising:
at least one database configured to store:
an electronic representation of a portfolio operating company, the portfolio operating company being a legal business entity, the electronic representation of the portfolio operating company including detailed ownership records of the portfolio operating company;
an electronic representation of an investment fund entity for investing in one or more portfolio operating companies, including an association with the electronic representation of the portfolio operating company and an ownership amount reflecting an ownership stake held by the investment fund entity in the portfolio operating company; and,
an electronic representation of a portfolio investment entity (PIE), including operational and legal data about the portfolio investment entity for performing logical operations thereon, and an association with the electronic representation of the investment fund entity;
wherein the electronic representation of an investment fund entity includes detailed investment records corresponding to individual investments made by the investment fund entity in the portfolio operating company.

2. The system of claim 1, further comprising a business logic module configured to compute each of:
a present valuation of the portfolio operating company;
a present ownership fraction derived from the ownership amount stored in the electronic representation of the investment fund entity; and,
a present valuation of the ownership stake held by the investment fund entity in the portfolio operating company based on the present valuation and the present ownership fraction.

3. The system of claim 1, wherein the detailed investment records corresponding to individual investments made by the investment fund entity in the portfolio operating company include a stock share class, a number of shares, an amount invested, and a date of transaction.

4. The system of claim 1, further comprising a user interface module configured to display or output a chart showing a percentage allocation of each of a plurality of portfolio operating companies in the investment fund entity, and, to display a tabular view showing the percentage allocation.

5. The system of claim 1, further comprising a user interface module configured to display or output a chart showing a present value of each of a plurality of portfolio operating companies in the investment fund entity, and, to display a tabular view showing the present value.

6. The system of claim 1, further comprising a user interface module configured to display or output a future scenario planner with one or more of editable growth estimates and projected future decision points.

7. The system of claim 1, further comprising a user interface module configured to display or output a chart showing investments in one or more portfolio operating companies across a plurality of investment fund entities, based on associations stored within the electronic representation of the portfolio investment entity.

8. The system of claim 1, further comprising an authentication module configured to permit a person associated with the portfolio investment entity to view, edit, and operate on data of the electronic representation of the investment fund entity for which the person is granted access.

9. The system of claim 1, further comprising a delegation manager configured to perform authorization to perform an action in the system using one or more or permissions, roles, principals, or groups, and configured to permit principals to delegate a permission or role to another principal in the context of a particular investment fund entity or portfolio investment company.

10. A method for investment entity management, comprising:
storing, in a database, an electronic representation of a portfolio operating company, the portfolio operating company being a legal business entity, the electronic representation of the portfolio operating company including detailed ownership records of the portfolio operating company;
storing, in the database, an electronic representation of an investment fund entity for investing in one or more portfolio operating companies, including an association with the electronic representation of the portfolio operating company and an ownership amount reflecting an ownership stake held by the investment fund entity in the portfolio operating company; and,
storing, in the database, an electronic representation of a portfolio investment entity (PIE), including operational and legal data about the portfolio investment entity for performing logical operations thereon, and an association with the electronic representation of the investment fund entity,
wherein the electronic representation of an investment fund entity includes detailed investment records corresponding to individual investments made by the investment fund entity in the portfolio operating company.

11. The method of claim 10, further comprising computing each of:
a present valuation of the portfolio operating company;
a present ownership fraction derived from the ownership amount stored in the electronic representation of the investment fund entity; and,
a present valuation of the ownership stake held by the investment fund entity in the portfolio operating company based on the present valuation and the present ownership fraction.

12. A non-transitory computer-readable medium that, when executed on a computer, performs operations comprising:
storing, in a database, an electronic representation of a portfolio operating company, the portfolio operating company being a legal business entity, the electronic representation of the portfolio operating company including detailed ownership records of the portfolio operating company;
storing, in the database, an electronic representation of an investment fund entity for investing in one or more portfolio operating companies, including an association with the electronic representation of the portfolio operating company and an ownership amount reflecting an ownership stake held by the investment fund entity in the portfolio operating company; and,
storing, in the database, an electronic representation of a portfolio investment entity (PIE), including operational and legal data about the portfolio investment entity for performing logical operations thereon, and an association with the electronic representation of the investment fund entity,
wherein the electronic representation of an investment fund entity includes detailed investment records corresponding to individual investments made by the investment fund entity in the portfolio operating company.

13. The non-transitory computer-readable medium of claim 12, wherein the operations further comprise computing each of:
a present valuation of the portfolio operating company;
a present ownership fraction derived from the ownership amount stored in the electronic representation of the investment fund entity; and,
a present valuation of the ownership stake held by the investment fund entity in the portfolio operating company based on the present valuation and the present ownership fraction.
